(19) United States
(12) Patent Application Publication
(10) Pub. No.: US 2013/0145644 A1
(43) Pub. Date: Jun. 13, 2013

(54) PROCESS FOR OPERATING A WASHER DRYER WITH A SENSOR PLACED BETWEEN A TUB AND A HEAT EXCHANGER, AND RELATED WASHER DRYER

(71) Applicants: Harald Moschütz, Grossbeeren (DE); Vladimir Proseanic, West Bloomfield, MI (US); Svetlana Visnepolschi, West Boomfield, MI (US)

(72) Inventors: Harald Moschütz, Grossbeeren (DE); Vladimir Proseanic, West Bloomfield, MI (US); Svetlana Visnepolschi, West Boomfield, MI (US)

(73) Assignee: BSH HOME APPLIANCES CORPORATION, Irvine, CA (US)

(21) Appl. No.: 13/324,147

(22) Filed: Dec. 13, 2011

(51) Int. Cl. F26B 7/00; D06F 35/00

(52) U.S. Cl. 34/427; 68/20

(57) ABSTRACT

A method for operating a washer dryer comprising a tub, a drum mounted in the tub to be rotatable around an essentially horizontal axis for receiving laundry items, a process air circuit comprising an air heater and a blower to heat and circulate the heated air through the drum, a heat exchanger to condense moisture from the process air coming out of the drum, a sensor placed in the process air circuit between the tub and the heat exchanger, and a rinsing device, whereby the rinsing device flushes the sensor in a flushing phase with an aqueous cleaning liquid when the temperature T in the process air circuit between the tub and the heat exchanger is in a temperature range between an upper temperature limit Tₘₐₓ^{set} and a lower temperature limit Tₘᵢₙ^{set}. The invention also relates to a washer dryer for performing this method.

### BACKGROUND OF THE INVENTION

The present invention relates broadly to methods for operating washer dryer appliances and, more particularly, to a method for operating a washer dryer with a sensor disposed between a tub and a heat exchanger. The present invention accordingly relates to a method for operating a washer dryer comprising a tub, a drum mounted in the tub to be rotatable around an essentially horizontal axis for receiving laundry items, a process air circuit comprising an air heater and a blower to heat and circulate the heated air through the drum, a heat exchanger to condense moisture from the process air coming out of the drum, and a sensor in the process air circuit between the tub and the heat exchanger, and a rinsing device, as well as a washer dryer suitable for carrying out this method.

Drum washing machines are popular due to their water saving features and avoidance of damage to laundry being washed. In recent years, washer dryers, i.e. drum washing machines with a drying function, have become popular among consumers because they combine the functions of a normal washing machine and a dryer in a compact manner. Moreover, a washer dryer is already provided with a water supply access, such that water is available not only for the washing of laundry, but also for further treatment steps. For example, when drying, such a washer dryer takes in air through a fan set on an outside of a tub containing the drum, and heats the air with an air heater. The heated air enters the tub and the inside of the drum where it takes up moisture contained in the laundry. The moisture is carried away, condensed in a condensing unit mounted on an outer side of the tub and drained out of the washing machine.

In general, washer dryers dry the laundry at substantially constant temperatures and in preset periods of time. Such method may however result in an overdrying of the laundry when the load of laundry to be dried is too small or in an underdrying of the laundry when the load of laundry is too large. To cope with these problems, temperature sensors, humidity sensors, or both have been placed inside the washer dryer to detect the temperature and/or humidity. Since the degree of dryness can be determined based on the sensor signals, a drying method can be controlled with relative accuracy.

Document GB 2 082 742 A discloses a dryer which controls the drying time according to the internal temperature change rate in combination with a consideration of the type of clothes being washed and a predetermined degree of dryness.

Document CN 1 746 379 A discloses a drum washing machine with a drying function which has an upper temperature sensor and a lower temperature sensor mounted respectively on an upper end and a lower end of a vertical part of a hot air circulating pipe. The drum washing machine has a control unit that determines a degree of dryness reached, based on the temperature difference detected between the upper and lower temperature sensors to allow the control of the drying method.

Document CN 1 503 864 A discloses a control unit for detecting the dryness in an air exhaust dryer based on the signals detected by a humidity detection unit and a temperature detection unit whereby the drying method can be controlled.

Document CN 1 611 659 A discloses a drum washing machine system control device that determines the load of the laundry to be dried based on measured data from a humidity sensor set on a condensing pipe. Also disclosed is a drying device for drum washing machines which adjusts the temperature of a heater based on a laundry load, and a control method for the drying device.

Document WO 2007/138019 A1 discloses a drum washing machine with a drying program and a control method for the same. The washing machine includes a tub to hold water; a drum rotatable set in the tub; a heating drying tunnel configured outside said tub; a first temperature detection unit set in the said tub; and a system control unit which controls the drying program based on the signal fed back from the first temperature detection unit.

Documents WO 2009/130145 A1 and US 2011/0030239 A1 each disclose a household appliance for drying a laundry item, the household appliance comprising a treatment chamber to receive the laundry item; a closed process air circuit to feed process air through the treatment chamber, the closed process air circuit comprising inter alia: a blower to move the process air; a condenser to condense out moisture carried in the process air; a heater to heat the process air; a first measurement device to determine a temperature of the process air when the process air enters the treatment chamber to provide a first measurement signal; and a controller to control the blower and the heater as a function of the first measurement signal. Several temperature sensors on the process air duct or the cooling air duct can be used to control the drying method with redundancy and thus with a particularly high level of stability, for example, a temperature sensor between the tub and the heat exchanger.

The use of a sensor between the tub and the heat exchanger can pose a serious problem in that fluff, or lint, and inorganic deposits can accumulate on the sensor. The deposits may result in the formation of limestone on the sensor which may hamper the proper functioning of the sensor and thus of the washer dryer. The accumulation of fluff and of inorganic deposits is especially important in washer dryers with an air-air heat exchanger, since a quantity of fluff usually accumulates on the heat exchanger. This fluff can disturb, for example, a correct measurement of the temperature of the process air and may prevent an accurate functioning of the washer dryer. It has therefore been known to clean this temperature sensor, including an NTC sensor, by means of a special rinsing method.

Document EP 2 037 035 A1 discloses a laundry treatment device having a drying program, comprising a water tub, a rotatable drum disposed within the water tub, a heating assembly for heating air into dry hot air, a condensing assembly for condensing moisture contained in relatively humid hot air, and a blowing device for driving an air circulation, wherein an air circulating loop is formed among said heating assembly and blowing device. A spraying device for flushing fluff accumulated on the condensing assembly is disposed between the condensing assembly and the blowing device.

The flushing water may contain carbonates whose solubility decreases when the temperature is increased. Higher temperatures thus cause a shift of the equilibrium to calcium carbonate that can be deposited. As a result, limestone may accumulate at the surface of a sensor, in particular a sensor in between the tub and the heat exchanger.

### SUMMARY OF THE INVENTION

In view of this situation, an object underlying the present invention is the provision of a method for the operation of a washer dryer with a sensor in a connecting part between the tub and the heat exchanger which allows a reliable and safe operation of the washer dryer during the drying phase, as well as a washer dryer that is suitable for conducting this method. In particular, the method should allow alleviating the problem of deposit formation on a sensor in between the heat exchanger and the tub.

In accordance with the present invention, this object is achieved by a method for operating a washer dryer and a washer dryer with the features of the independent claims. Preferred embodiments of the invention are detailed in the respective dependent claims. Preferred embodiments of the washer dryer correspond to preferred embodiments of the method, even if they are not referred to herein in detail.

The invention thus relates to a method for operating a washer dryer comprising a tub, a drum mounted in the tub to be rotatable around an essentially horizontal axis for receiving laundry items, a process air circuit comprising an air heater and a blower to heat and circulate the heated air through the drum, a heat exchanger to condense moisture from the process air coming out of the drum and a rinsing device. The method includes the steps of:

(1) determining a temperature T in the process air circuit between the tub and the heat exchanger using at least one sensor disposed in the process air circuit between the tub and the heat exchanger for at least controlling a drying phase; and

(2) flushing the sensor with an aqueous cleaning liquid using the rinsing device in a flushing phase responsive to at least one of a determination that the temperature T in the process air circuit between the tub and the heat exchanger is in a temperature range between an upper temperature limit Tₘₐₓ^{set} and a lower temperature limit Tₘᵢₙ^{set}.

In a preferred embodiment of the method, the steps are preformed on a washer dryer wherein at least one sensor in the process air circuit between the tub and the heat exchanger is at least one of a first temperature sensor and a humidity sensor. In this embodiment, the first temperature sensor can be used to determine the temperature in the process air circuit between the tub and the heat exchanger and to verify that this temperature is in a temperature range between an upper temperature limit Tₘₐₓ^{set} and a lower temperature limit Tₘᵢₙ^{set} to allow performing the flushing phase as prescribed by the method of the present invention.

In another preferred embodiment, the first temperature sensor has an elongate body with a temperature sensitive tip. The first temperature sensor is most preferably an NTC (Negative Temperature Coefficient) temperature sensor. Advantageously, the temperature sensor is inclined in the direction of the tub.

Preferably, the method of the present invention includes cooling the process air after a drying phase has been terminated by circulating the process air through the heat exchanger until the temperature in the process air circuit between the tub and the heat exchanger is lower than the upper temperature limit Tₘₐₓ^{set}.

It is preferred that the drying phase is terminated by shutting off the air heater when a set maximum drying temperature Tₘₐₓ^{dry} and/or a set lower humidity level Hₘᵢₙ^{dry} is reached.

Accordingly, the method of the invention including a flushing phase can be carried out during a drying phase and/or thereafter. In that regard, it may occur that a set lower humidity level Hₘᵢₙ^{dry} is reached before Tₘₐₓ^{set} is reached in the drying phase. Preferably, the set lower humidity level Hₘᵢₙ^{dry} is about 15%, or more preferably, about 10%. It has been shown by experiments that under these conditions, fluff is generated from laundry in a considerable relative amount. Thus, it might be useful to carry out the method of the invention when one of these conditions exists.

Preferably, the method of the present invention is carried out after a drying phase has been completed and the process air has been cooled below Tₘₐₓ^{set}.

In the method of the present invention it is preferred that the upper temperature limit Tₘₐₓ^{set} is about 65° C., preferably about 60° C.

Water may be used as an aqueous cleaning fluid. In that case, it may be useful to use water from the water supply. Ingredients may be added to the water that assist in the cleaning method. In a preferred method according to the present invention, the aqueous cleaning fluid contains ingredients that dissolve inorganic deposits on the sensor. A useful ingredient may be an acid that assists in dissolving calcium carbonate.

In a preferred method of the present invention, the drum is rotated during the flushing phase to cause the sensor to vibrate. In this embodiment it is preferred that a connecting part between the tub and the heat exchanger is sufficiently rigid to allow the transmission of vibrations of the tub. Moreover, the transmission of vibrations is more pronounced when the sensor is closer to the tub than to the heat exchanger. This allows the first temperature sensor, for example an NTC temperature sensor, to be assembled close to the moving oscillation system vibrations from the rotating drum which provide forces hindering any adhesion at the sensor surface and can assist the removal of water drops, fluff and inorganic deposits.

In a preferred embodiment, the flushing phase consists of at least two flushing steps.

For example, a first flushing step can be carried out with half of the intended amount of aqueous cleaning liquid intended for the flushing phase. It may then be examined, for example by observing the temperature or humidity by means of the sensor, whether the cleaning of the sensor was sufficient.

It is moreover conceivable that a first flushing step is carried out during a drying phase and the second flushing step is carried out after the drying phase.

If the aqueous cleaning liquid contains ingredients that assist in the cleaning method it may be advantageous to carry out a second flushing step with pure water.

In all these embodiments more than two flushing steps can be carried out.

In a preferred embodiment of the method, the washer dryer used includes a second temperature sensor to measure a temperature Tₐₚₚ of process air which is deemed to be the temperature of the process air in the process air circuit between the tub and the heat exchanger. This can be especially useful if the sensor is a humidity sensor or if the first temperature sensor is strongly affected by fluff of inorganic deposits.

In a particularly preferred embodiment, the washer dryer used in the method comprises a first temperature sensor and a second temperature sensor and the cleaning effect of the flushing method is controlled by verifying that a temperature difference ΔT at the first temperature sensor and the second temperature sensor of process air driven through the process air circuit by the blower is within a set range ΔT_{adm}. If both temperature sensors function properly indicating that the first temperature sensor is sufficiently clean, a measured temperature difference between the first and the second temperature sensor should be small.

In a preferred method of the present invention, a drying phase is conducted by controlling the blower and the air heater such that a set maximum temperature Tₘₐₓ for the temperature of the warm air is not exceeded.

The present invention is also directed to a washer dryer including a tub, a drum mounted in the tub to be rotatable around an essentially horizontal axis for receiving laundry items, a process air circuit comprising an air heater and a blower to heat and circulate the heated air through the drum, a heat exchanger to condense moisture from the process air coming out of the drum, a sensor in the process air circuit between the tub and the heat exchanger, and a rinsing device, wherein the washer dryer is provided with means to carry out a flushing phase wherein the rinsing device flushes the sensor with an aqueous cleaning liquid, that takes place when the temperature in the process air circuit between the tub and the heat exchanger is in a temperature range between an upper temperature limit Tₘₐₓ^{set} and a lower temperature limit Tₘᵢₙ^{set}.

The means to carry out the flushing phase can be a control unit specifically adapted to allow conducting a flushing phase as prescribed herein.

The sensor in the washer dryer of the present invention is preferably a first temperature sensor.

In a preferred embodiment, the washer dryer includes a first temperature sensor and a second temperature sensor.

Preferably, in the embodiment where a first temperature sensor is used, the first temperature sensor is placed in the connecting part between the tub and the heat exchanger in a manner that it can measure the temperature in or close to the center of the process air flow. This would allow a more precise control of a drying phase. Thus, the first temperature sensor is preferably arranged such that it may be in contact with the center of the process air flow or the connecting part may be provided with guiding means that guide the process air flow towards the first temperature sensor.

A connecting part between the tub and the heat exchanger can be a part which is integrally formed into the body of the heat exchanger or the tub. Alternatively, it can form a separate piece which is placed between the tub and the heat exchanger. In a particular preferred embodiment, the connecting part is a flexible hose connecting the tub with the heat exchanger.

The washer dryer of the present invention includes a heat exchanger. In principle, a heat exchanger might be realized by using relatively cold water from the water supply or another source to condense the moisture carried by the process air in a washer dryer. This embodiment can be realized fairly easily, but it consumes rather large amounts of water.

It is thus preferred according to the present invention to use an indirectly cooled condenser as a heat exchanger, in which there is no direct contact between the warm and humid process air to be cooled and the cooling agent used. An indirectly cooled condenser can be realized for example as an air-cooled condenser, i.e., an air-air heat exchanger, with the air serving as the cooling agent being taken usually from the room wherein the washer dryer is placed. The used air is usually fed back to this room after it has been used in the cooling step.

The indirectly cooled condenser may be also embodied as a heat sink of a heat pump in the washer dryer. The heat pump takes in heat from the hot and humid process air in the condenser, pumps this heat to the air heater in the process air circuit and discharges it there back to the process air. Such a heat pump can be embodied as a compressor heat pump, in which a cooling agent circulates which is cyclically evaporated in the condenser as it absorbs heat from the air flow and condensed in the condenser as it emits heat to the air flow, but the heat pump may also be operating by means of a reversible sorption method, a regenerative gas circuit method or the Peltier effect.

In a particularly preferred embodiment of the present invention, the heat-exchanger is an air-air heat exchanger.

The rinsing device as used in the washer dryer of the present invention is in general also used for cleaning the heat exchanger, if an indirectly cooled heat exchanger is used. Accordingly, the rinsing device is in general provided above the heat exchanger.

In general, a washer dryer is connected to a water supply system provides water for a detergent rinsing device such that portions of detergent or auxiliaries can be flushed into the tub. Such a water supply system may comprise a bifurcation to the heat exchanger such that water from the water supply system may be used for the rinsing device, as cooling liquid in the heat exchanger, or both.

A washer dryer may also include a suds discharge system at its base including a drain valve and a suds pump and any necessary pipes. Further, a washer dryer may contain laundry agitators and/or scooping devices. A plurality of such laundry agitators and/or scooping devices, in particular a number of three or four, is preferred. The laundry agitator may be cast into the drum as an integral component or inserted into the drum as an additional component.

A washer dryer generally has switching means for rotating and stopping the drum. Moreover, a washer dryer according to the present invention preferably includes a sensor for determining a quantity of liquid disposed in the suds container. The sensor is usually placed in a lower part of the tub. A conventional sensor for determining the water level can be used as a sensor for determining the quantity of liquid disposed in the tub, i.e. the suds container, the sensor signal of which is tracked during the method. Such a sensor generally measures a hydrostatic pressure p and/or a temporal gradient (Δp/Δt)₁ of the hydrostatic pressure p.

In addition, a washer dryer in general contains a heater for the direct heating of an aqueous liquid, for example suds. This heater, termed herein “water heating”, is in general disposed in the tub below the drum.

The invention has numerous advantages. The washer dryer of the present invention can operate with a sensor between the tub and the heat exchanger that can be cleaned easily from fluff or inorganic salts accumulated on the sensor. It is of particular advantage that the present invention removes fluff and of inorganic deposits without the danger of a formation of insoluble inorganic deposits on the sensor, for example, the formation of limestone. Thus, in embodiments of the present invention, a first temperature sensor provides highly reliable signals regarding the temperature of the process air leaving the drum and the tub over a long service time. The operation of the washer dryer can be controlled precisely such that the risk of an overheating of the laundry items to be dried can be avoided. This is of particular advantage when sensitive laundry items are being dried. The protection of sensitive laundry items such as wool, silk or lace during a drying phase is thus significantly improved. These advantages can be achieved without an increased water level and without additional water consumption. The water dryer can thus be operated safely without using large amounts of water.

### BRIEF DESCRIPTION OF THE DRAWINGS

FIG. 1 is a sectional diagrammatic view of a washer dryer configured for carrying out the method of the present invention.

### DETAILED DESCRIPTION OF EXEMPLARY EMBODIMENTS OF THE PRESENT INVENTION

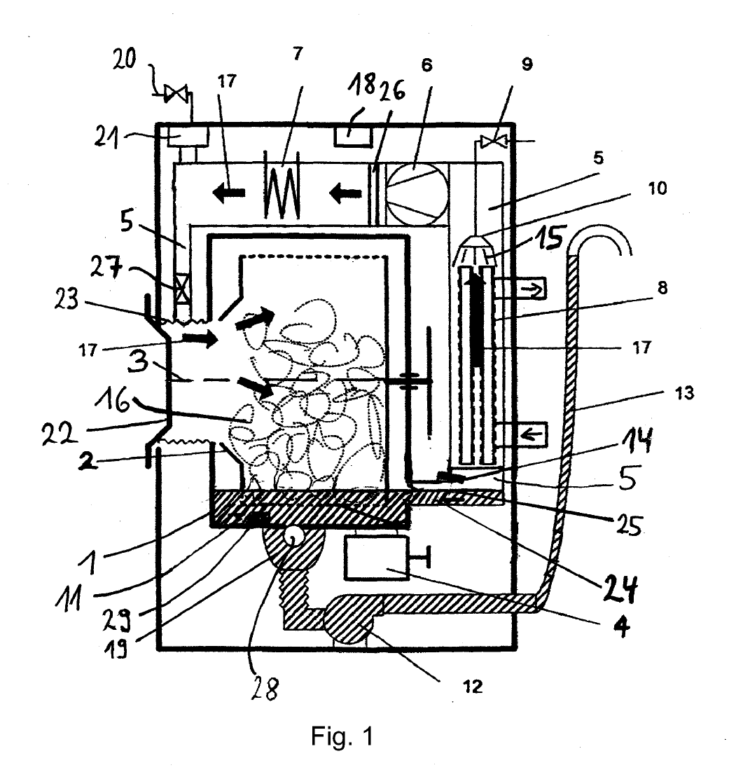

Turning now to the drawings and, more particularly to FIG. 1, a washer dryer according to one preferred embodiment of the present invention, includes a tub 1 (also to be referred to as “suds container”) and a drum 2 which is placed in the tub 1 such that it can be rotated around an essentially horizontal axis 3. Laundry items 16 to be treated are placed in the drum 2. The tub 1 is connected by means of a flexible hose 25 as connecting part to a heat exchanger 8 which is herein an air-air heat exchanger.

The tub is connected via a suds draining duct 19 to a pump 12 which moves an aqueous liquid 11, for example suds, out of the tub 1 and via a waste water conduit 13 out of the washer dryer. The drum 2 is driven by means of a drive motor 4.

The drum 2 is filled through a door 22 that allows the access to the interior of the drum with laundry 16 items to be treated. In order to wash laundry in the washer dryer, the washer dryer is connected to a water feed line 20. The water feed line 20 is connected to a detergent rinsing shell 21 from which detergent and auxiliary agents can be flushed with the aid of water from the water feed line 20 into the tub 1 for conducting a washing process in the washer dryer. This is achieved in this embodiment through a part of the process air circuit 5 and a sleeve 23.

For drying wet laundry items in the drum 2 of the washer dryer of FIG. 1 which operates according to the principle of circulating air, the air heated by the air heater 7 (“process air”) is driven through the process air circuit 5 with the aid of a blower 6. Thus, heated process air enters the tub 1 and the drum 2, respectively, through the sleeve 23. The warm, humid process air which results after the passage of the process air through the drum 2, where it has taken up moisture from the wet laundry items 16, arrives at a rear exit 24 of the tub 1 and thereafter at the heat exchanger 8. There, the process air is cooled with cold air and the moisture contained in the process air condenses as a result of the cooling in the air-air heat exchanger 8. The condensate may be collected in a condensate container (not shown here) or may flow back to the tub 1 and finally to the suds draining duct 19 whereby it can be disposed through the waste water conduit 13. The dried air flows inside the process air circuit 5, is heated again by the air heater 7 and then introduced again via the sleeve 23 into the drum 2. As seen in FIG. 1, filled arrows 17 indicate the flow of the warm air, while short unfilled arrows indicate the flow of the cooling air inside the air-air heat exchanger 8.

Between the tub 1 and the air-air heat exchanger 8, for example, in a flexible hose 25, a sensor 14 is placed which is used to control a drying phase in the washer dryer. The sensor 14 is here a first temperature sensor 14 and more particularly an NTC sensor.

The washer dryer shown in FIG. 1 is configured to carry out a flushing phase in accordance with the method disclosed hereinabove. To this end, the washer dryer of FIG. 1 has a rinsing device 10 which is placed here above the heat exchanger 8. Accordingly, the rinsing device 10 allows flushing both the air-air heat exchanger 8 and the sensor 14 with an aqueous cleaning liquid 15, for example by spraying. Moreover, the rinsing device 10 is in this embodiment connected by means of a water valve 9 to a water supply system, for example the water feed line 20. Thus, as aqueous cleaning liquid 15, water from a water supply system can be used. Alternatively—although not shown here—an aqueous cleaning liquid 15 to be used may contain ingredients that assist in the cleaning method, for example, removing inorganic deposits like limestone from the sensor 14. In this case, an acid may be used.

In order to allow a more precise control of a flushing phase of the method of the present invention, and also a drying phase in the washer dryer, a second temperature sensor 27 is placed in the process air circuit 5 close to the door 22.

FIG. 1 also shows a control unit 18 which controls the operation of the washer dryer based inter alia on the signals received from the first and second temperature sensor and in particular the control of the method of the present invention. The water valve 9, the air heater 7 and a water heater 28 are all controlled by the control unit 18 as a function of a program workflow, which is associated with a time program and/or with the achievement of certain measured values of parameters such as the level of an aqueous liquid, for example, the suds level, suds temperature and the speed of the drum 2.

A drying phase is usually carried out by circulating process air repeatedly through the process air circuit 5 until a desired degree of dryness in the laundry items 16 is obtained. The washer dryer of FIG. 1 is configured for precisely controlling the drying phase by controlling the blower 6 and the air heater 7 such that a set maximum temperature Tₘₐₓ for the temperature of the process air is not exceeded.

A hydrostatic pressure sensor 29 for measuring the hydrostatic pressure p in the suds container 1 may also provided.

It will therefore be readily understood by those persons skilled in the art that the present invention is susceptible of a broad utility and application. While the present invention is described in all currently foreseeable embodiments, there may be other, unforeseeable embodiments and adaptations of the present invention, as well as variations, modifications and equivalent arrangements, that do not depart from the substance or scope of the present invention. The foregoing disclosure is not intended or to be construed to limit the present invention or otherwise to exclude such other embodiments, adaptations, variations, modifications and equivalent arrangements, the present invention being limited only by the claims appended hereto and the equivalents thereof.

What is claimed is:

1. A method for operating a washer dryer having a tub; a drum mounted in the tub to be rotatable around an essentially horizontal axis for receiving laundry items; a process air circuit including an air heater and a blower to heat and circulate the heated air through the drum; a heat exchanger to condense moisture from the process air coming out of the drum; and a rinsing device, the method comprising the steps of:
determining a temperature T in the process air circuit between the tub and the heat exchanger using at least one sensor disposed in the process air circuit for at least controlling a drying phase; and
flushing the sensor with an aqueous cleaning liquid using the rinsing device in a flushing phase responsive to at least one of a determination that the temperature T in the process air circuit between the tub and the heat exchanger is in a temperature range between an upper temperature limit and a lower temperature limit.

2. The method according to claim 1 wherein the method further includes the step of providing at least one sensor in the process air circuit between the tub and the heat exchanger including one of a first temperature sensor and a humidity sensor.

3. The method according to claim 2 wherein the step of determining the temperature using a sensor includes using a first temperature sensor having an elongate body with a temperature sensitive tip.

4. The method according to claim 3 wherein the step of determining the temperature using a sensor includes using a first temperature sensor formed as an NTC temperature sensor.

5. The method according to claim 1 and further comprising the step of cooling the process air after a drying phase has been terminated by circulating the process air through the heat exchanger until the temperature in the process air circuit between the tub and the heat exchanger is lower than the upper temperature limit.

6. The method according to claim 5 wherein the at least one sensor in the process air circuit between the tub and the heat exchanger is one of a first temperature sensor and a humidity sensor and further comprising the step of terminating the drying phase by shutting off the air heater when at least one of a set maximum drying temperature and a set lower humidity level is reached.

7. The method according claim 1 wherein the step of flushing the sensor includes flushing the sensor responsive to at least one of a determination that the temperature T in the process air circuit between the tub and the heat exchanger is in a temperature range between about 65° C. and a lower temperature limit.

8. The method according claim 1 wherein the step of flushing the sensor with an aqueous cleaning liquid includes flushing the sensor with an aqueous cleaning containing ingredients configured for dissolving inorganic deposits on the sensor.

9. The method according to claim 1 whereby the step of flushing the sensor includes rotating the drum to cause the sensor to vibrate.

10. The method according to claim 1 wherein the step of flushing the sensor consists of at least two flushing operations.

11. The method according claim 1 wherein the step of determining a temperature includes determining a temperature using a second temperature sensor to measure a temperature Tₐₚₚ of process air which is deemed to be the temperature of the process air in the process air circuit between the tub and the heat exchanger.

12. The method according to claim 1 wherein the step of determining a temperature includes determining a temperature using a first temperature sensor and a second temperature sensor and the cleaning effect of the flushing method is controlled by verifying that a temperature difference ΔT at the first temperature sensor and the second temperature sensor of process air driven through the process air circuit by means of the blower is within a set range ΔT_{adm}.

13. A washer dryer having a tub; a drum mounted in the tub to be rotatable around an essentially horizontal axis for receiving laundry items; a process air circuit comprising an air heater and a blower to heat and circulate the heated air through the drum; a heat exchanger to condense moisture from the process air coming out of the drum; a sensor placed in the process air circuit between the tub and the heat exchanger; and a rinsing device; the washer dryer comprising, means for carrying out a flushing phase wherein the rinsing device flushes the sensor with an aqueous cleaning liquid, when the temperature in the process air circuit between the tub and the heat exchanger is in a temperature range between an upper temperature limit Tₘₐₓ^{set} and a lower temperature limit Tₘᵢₙ^{set}.

14. The washer dryer according to claim 13 wherein the heat-exchanger is an air-air heat exchanger.

15. The washer dryer according to claim 14 wherein the sensor is a first temperature sensor.
